(19) United States
(12) Patent Application Publication
(10) Pub. No.: US 2006/0287912 A1
(43) Pub. Date: Dec. 21, 2006

(54) Presenting advertising content

(76) Inventor: Vinayak Raghuvamshi, Alexandria, VA (US)

Correspondence Address: FISH & RICHARDSON P.C., P.O. BOX 1022, MINNEAPOLIS, MN, 55440-1022, US

(21) Appl. No.: 11/154,733

(22) Filed: Jun. 17, 2005

(51) Int. Cl. G06Q 30/00

(52) U.S. Cl. 705/14

(57) ABSTRACT

In an implementation, a client system receives a media stream from a content distribution system and presents the received media stream. When an advertising opportunity occurs in the media stream, the content distribution system inserts one or more initial ads and meta-data associated with the advertising opportunity into the media stream. The client system detects the meta-data, which causes the client system to buffer at least a portion of one or more follow-up ads from another source while the initial ad is being presented. Once the client system finishes presenting the initial ad(s), the client system switches to presenting the one or more follow-up ads during the advertising opportunity, and then switches back to the media stream at the end of the advertising opportunity.

### TECHNICAL FIELD

This description relates to presenting advertising content.

### BACKGROUND

Dynamic content may be delivered and presented to users across packet-based networks, such as the Internet. Dynamic content generally refers to content that continuously or nearly continuously changes over time (i.e., content with a temporal dimension), such as audio and/or visual content. When sent over a packet-based network, such dynamic content may be, for example, downloaded content that is fully transmitted to a client system before the client system presents the content. Alternatively, such dynamic content may be, for example, streaming content such as streaming audio and/or video. Streaming content generally refers to content that is sent as a continuous stream and presented as it is received at a client system. Thus, a user of a client system that is receiving streaming content does not typically wait until the content is fully downloaded before the dynamic content is presented, as is the case for downloaded content. Rather, the client system receiving streaming content usually downloads and buffers a portion of the dynamic content. The client system then presents the buffered portion as the rest of the dynamic content is downloading.

Streaming content may be sent from a pre-encoded (or otherwise pre-prepared) file (referred to as “on-demand” streaming) or may be distributed as part of a live broadcast feed (referred to as “live” streaming). For live streaming, a live broadcast feed is typically encoded into a compressed digital signal as the broadcast feed is received, for example, by an encoder and the encoded signal is transmitted from a server that is able to do multicast; that is, able to send the same signal to multiple client systems at the same time. The broadcast feed may depict live activity (that is, activity occurring as the feed is broadcasted) or may depict previously recorded activity.

Different types of dynamic content may be included in streaming content or downloaded content. The different types of dynamic content may include, for example, programming content and advertising content. Programming content is generally the editorial content that a user desires to have presented. Advertising content is generally any other content besides the editorial content and is typically content that promotes particular services or goods. Advertising content may be, for example, previews for programming content being offered in the future (referred to as “previews”), an indication of the source of programming content (referred to as “branding”), or promotions to buy or otherwise acquire specific products or services (referred to as “advertisements”). A piece of advertising content will generally be referred to in this document as an “ad” and, accordingly, the term “ad” encompasses previews, branding, advertisements and other forms of advertising content.

Both programming content and advertising content may be inserted into a single media stream that is provided to a client system. However, it is often desirable to provide programming content to a client system on a first media stream, but allow the client system to present advertising content accessed from a second media stream. In the latter scenario, when the client system switches from the first stream (programming content) to the second stream (advertising content), there may be a delay before the advertising content is presented while the client system buffers the advertising content. In some circumstances, it may be possible to prevent such a delay by instructing the client system to begin buffering the advertising content prior to switching from the programming content to the advertising content.

### SUMMARY

Various implementations described below may be particularly advantageous when the timing of the switch from the programming content to the advertising content is not known sufficiently ahead of time to instruct the client system to begin buffering the advertising content. For example, a commercial break in some live sporting events, such as baseball and football, may be unscheduled, and occur immediately. In such a situation, the earliest that the client system is instructed to begin buffering advertising content from the second stream is at the beginning of the commercial break. Thus, in such a situation, the client system may not be able to buffer the ad stream before the switch is to occur. Instead, the client system begins buffering at the time the switch is supposed to occur, resulting in a delay before the client system presents an ad. This results in a discontinuous transition from the first stream to the second stream (and, hence, a discontinuous experience when transitioning from programming content to advertising content).

In one implementation, a smooth transition between programming content and advertising content is provided by inserting an initial ad at the end of the programming content. While presenting the initial ad, the client system buffers advertising content from the second stream. The initial ad is of sufficient length to allow the buffering to be completed before the switch, so that presentation of the ad begins without a buffering delay. In one general aspect, a media stream is received. The media stream includes programming content and an initial ad after the programming content. The programming content is presented and the initial ad is presented after the programming content. Prior to the end of the presentation of the initial ad, meta-data is received. In response to receiving the meta-data, a follow-up ad to be presented after the initial ad is accessed and presented after the initial ad.

Implementations may include one or more of the following features. For example, the meta-data may be encoded in the media stream. The meta-data may be encoded at a point in the media stream prior to the end of the initial ad that allows the follow-up ad to be accessed and at least a portion of the follow-up ad to be buffered prior to the end of the presentation of the initial ad. The follow-up ad may be accessed while presenting the initial ad and at least a portion of the follow-up ad may be buffered while presenting the initial ad. The follow-up ad may be accessed from a source other than a source from which the media stream is received. The media stream may be a live media stream.

In another general aspect, a request is received for selection of an initial ad for insertion into a media stream being sent to a client system. The initial ad is selected such that the initial ad has a length that allows the client system to access a follow-up ad while presenting the initial ad. An indication of the selected initial ad is provided, for example, to the client system. A request for selection of the follow-up ad is received from the client system and the follow-up ad is selected. An indication of the selected follow-up ad is provided to the client system to allow the client system to access the selected follow-up ad while the client system is presenting the initial ad.

Implementations may include one or more of the following features. For example, the indication of the selected initial ad and/or the indication of the selected follow-up ad may include an identifier of the selected initial ad and/or the selected follow-up ad. The identifiers may include a URL. Providing an indication of the selected follow-up ad may include providing the selected follow-up ad. The request for selection of a follow-up ad may be received from the client system while the client system is presenting the initial ad. In addition, the follow-up ad may be selected while the client system is presenting the initial ad. The follow-up ad may include one or more of an advertisement, a preview, and a branding segment. The initial ad may be selected such that the initial ad has a length that allows the client system to access and buffer at least a portion of the selected follow-up ad while presenting the initial ad.

In another general aspect, a media stream is provided for transmission to a client system. The media stream includes programming content. An indication that advertising content is to be inserted into the media stream is received and an initial ad is inserted into the media stream. The initial ad has a length that allows the client system to access a follow-up ad while presenting the initial ad. Meta-data is provided to the client system. The meta-data causes the client system to access the follow-up ad while presenting the initial ad and to present the follow-up ad after presenting the initial ad.

Implementations may include one or more of the following features. For example, the meta-data may be provided in the media stream before the initial ad. The meta-data may include an indication of the length of time during which the follow-up ad may be presented.

Implementations of the described techniques may include hardware, a method or process, and computer software on a computer-accessible medium.

The details of one or more implementations are set forth in the accompanying drawings and the description below. Other features will be apparent from the description and drawings, and from the claims.

### DESCRIPTION OF DRAWINGS

FIG. 1 is a block diagram illustrating one implementation of a live streaming environment.

FIGS. 2A and 2B, respectively, show an example of a portion of a live media stream, and an example of corresponding content presented by a media client application.

FIGS. 3A and 3B, collectively, illustrate an implementation of the operation of the system of FIG. 1.

FIG. 4 is a diagram illustrating a general process that may be performed, for example, by the client system of FIG. 1.

FIG. 5 is a diagram illustrating a general process that may be performed, for example, by the ad system of FIG. 1.

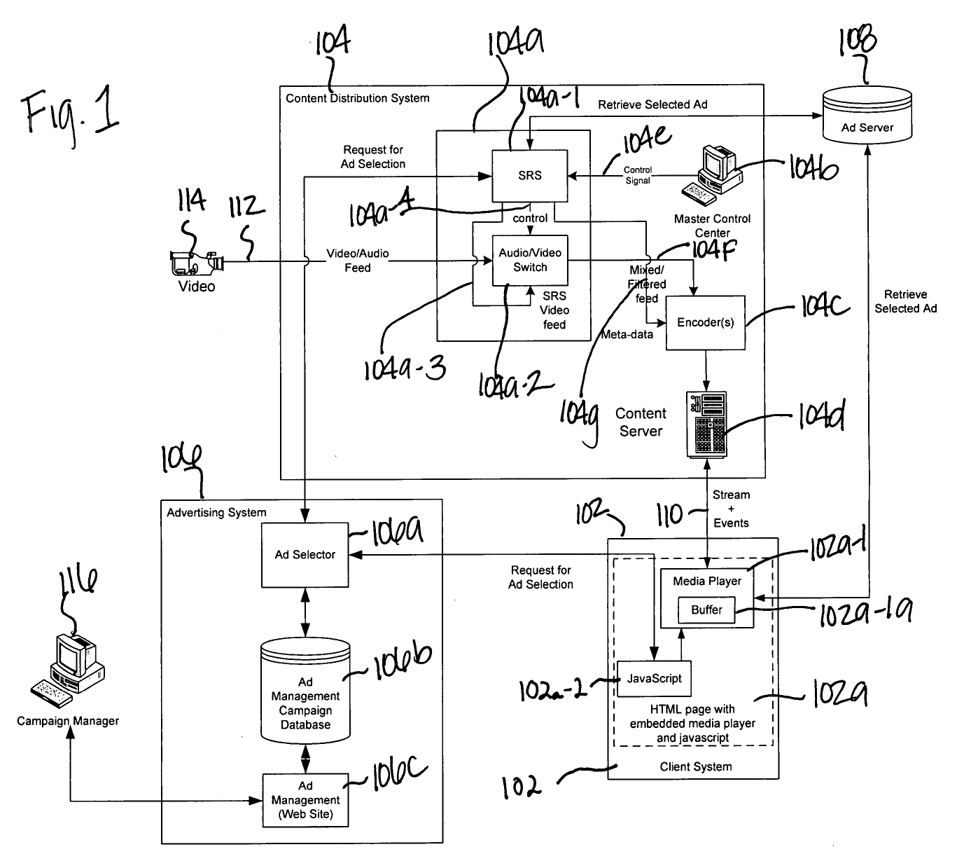

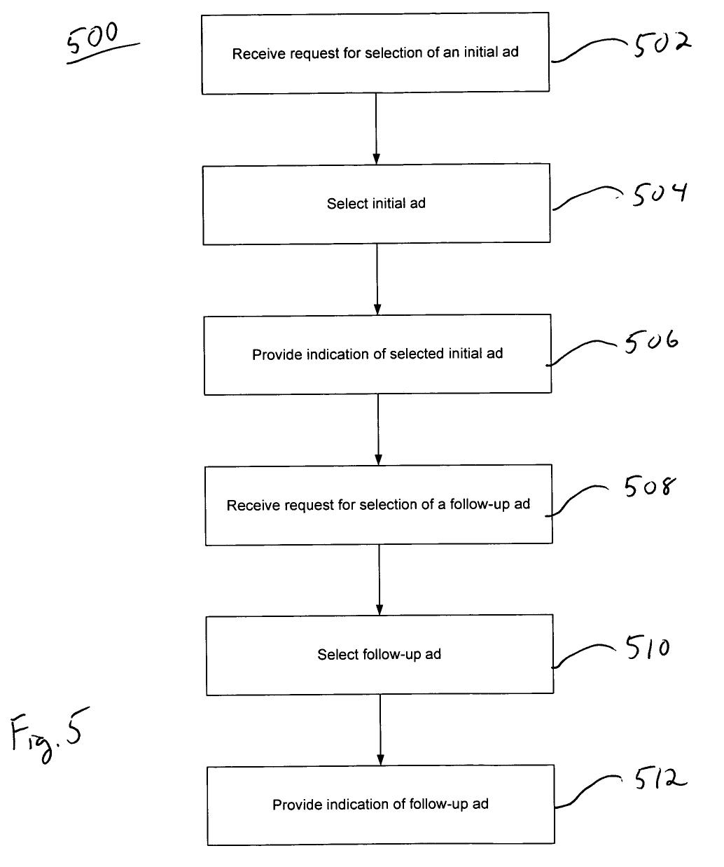

FIG. 4 is a diagram illustrating a general process that may be performed, for example, by the content distribution system of FIG. 1.

### DETAILED DESCRIPTION

An implementation is now described in detail that allows, among other things, an initial ad to be inserted into a stream after programming content, so as to allow a client system to buffer advertising content from a separate stream. Such an implementation allows, for example, a client system to receive live programming content having unscheduled commercial breaks and to present advertising content from the separate stream during the unscheduled commercial breaks without a buffering delay. This implementation addresses a pre-buffering issue for client-side ad insertion by always doing both server-side and client side-ad insertion, and while the client system is playing the server side ad, the client system also buffers the client-side ad(s). In other words, under this implementation, one can do client-side ad insertion without pre-notification to the client system—as long as the first ad in a spot break is a server-side ad and of a sufficient length (for example, at least 15 seconds long), any subsequent ad can be a client side ad.

Referring to FIG. 1, a live streaming environment 100 includes one or more client systems 102, a content distribution system 104, an advertising system 106, and an ad server 108 connected by one or more networks, such as the Internet (not shown explicitly).

In general, client system 102 receives and presents a live media stream 110. When an advertising opportunity (otherwise referred to as a spot break) occurs in live media stream 110, content distribution system 104 inserts into live media stream 110 one or more initial ads (for example, selected by advertising system 106) and meta-data associated with the advertising opportunity. Client system 102 detects the meta-data, which causes client system 102 to buffer at least a portion of one or more follow-up ads (for example, selected by advertising system 106) while the initial ad is being presented. Once client system 102 finishes presenting the initial ad(s), client system 102 switches to presenting the one or more follow-up ads during the advertising opportunity, and then switches back to live media stream 110 at the end of the advertising opportunity.

More particularly, in one implementation, content distribution system 104 sends a request for ad selection to advertising system 106, which selects one or more ads and sends an identifier (for example, a Uniform Resource Locator (URL)) of the selected ad back to content distribution system 104. Content distribution system 104 uses the identifier to request the selected ad from ad server 108, which returns the selected ad to content distribution system 104.

When a spot break occurs in live media stream 110, content distribution system inserts the selected ad into live media stream 110 as an initial ad, along with meta-data associated with the spot break. Client system 102 detects the meta-data, which causes client system 102 to send a request for ad selection to advertising system 106, which selects one or more follow-up ads for client system 102 to present during the spot break after the initial ad has been presented. Advertising system 106 returns identifiers (for example, URLs) for the one or more follow-up ads to client system 102.

While client system 102 presents the initial ad, client system 102 requests the one or more follow-up ads from ad server 108, which responds with an ad stream containing the one or more follow-up ads. Client system 102 then begins buffering the ad stream (and, hence, the one or more follow-up ads). Once client system 102 has finished presenting the initial ad in live media stream 110, client system 102 switches to the ad stream to present the one or more follow-up ads. While presenting the ad stream, client system 102 continues to buffer live media stream 110. Once the one or more follow-up ads have been presented, client system 102 switches back to live media stream 110.

By inserting an initial ad in live media stream 110, enough time may be provided while the initial ad is presented to allow client system 102 to buffer the ad stream containing the one or more follow-up ads so that the switch from live media stream 110 to the ad stream occurs without delay. This may allow live streaming environment 100 to accommodate client-side ad insertion (described below) with a smooth transition from programming content to ads.

In general, for a live stream, there are two general ways to present ads in a spot break: (1) inserting all ads at a server (server-side ad insertion); and (2) inserting all ads at a client system (client-side ad insertion). A server-side ad is inserted by content distribution system 104 into live media stream 110 and, therefore, each client system 102 connected to live media stream 110 receives the same ad. While server-side ads may be useful, they may not allow for individual targeting, since each client system 102 connected to live media stream 110 receives the same ad.

A client-side ad, on the other hand, is inserted by client system 102 (for example, the follow-up ads described above) by switching from live media stream 110 to an ad stream containing the ad in response to some signal indicating when the ad is to be shown. Client-side ads may be desirable because they may allow for individual targeting of ads. However, to perform client-side ad insertion, it may be desirable for client system 102 to immediately begin presenting the ad stream at the point the ad is to be presented, so as to provide a continuous experience.

However, if client system 102 has not had enough time to buffer ad stream 116 prior to the switch, then the transition to the ad stream may not be continuous. Such a situation may occur when programming content abruptly ends at an unscheduled commercial break and a client system is expected to insert all ads. Generally, when client system 102 presents a stream, a portion of the stream may need to be buffered before client system 102 can begin presenting the stream. This causes a delay (e.g., 15 seconds) from the time client system 102 accesses the stream until client system 102 can begin presenting the stream. Thus, when client system 102 switches from a first stream (for example, live media stream 110) to a second stream (for example, an ad stream), it may be desirable for client system 102 to begin buffering a portion of the second stream before the time at which client system 102 switches to the second stream in order to provide a smooth transition between streams. In other words, if client system 102 has not buffered the second stream before the switch, there may be a delay before client system 102 begins presenting the second stream.

Accordingly, if the initial ad is not placed in live media stream 110, but the timing of the spot break is known a sufficient amount of time before the spot break occurs, then client system 102 may be instructed to begin buffering the ad stream a sufficient amount of time before the switch to the ad occurs to allow for a smooth transition from the live stream to the ad stream. However, in some situations, the timing of the spot break may not be known sufficiently ahead of time to signal client system 102 to begin buffering the ad stream. For example, the spot breaks in some live sporting events, such as baseball and football, may be unscheduled, and occur immediately. In such situations, the earliest that client system 102 is signaled to begin buffering the ad stream is at the beginning of the spot break. Thus, in such a situation, client system 102 may not be able to buffer the ad stream before the switch is to occur. Instead, client system 102 begins buffering at the time the switch is supposed to occur, resulting in a delay before client system 102 presents the ad. This results in a discontinuous transition from live stream 110 to the ad stream which may cause confusion, and even irritation to a viewer at client system 102, as well as possibly resulting in a loss of advertising revenue.

However, by inserting an initial ad into live stream 110, and instructing client system 102 to begin buffering the ad stream, client system 102 may be ready to immediately present the ad stream at the end of the initial ad, thereby providing a smooth transition between live media stream 110 and the ad stream. While the initial ad may be inserted into live media stream 110 regardless of whether the spot break is scheduled beforehand, doing so may be particularly advantageous in situations where the spot break is unscheduled, because doing so can provide for a smooth transition between the programming content and the advertising content.

Client system 102, content distribution system 104, and advertising system 106 may be implemented using, for example, one or more of a general-purpose computer capable of responding to and executing instructions in a defined manner, a personal computer, a special-purpose computer, a workstation, a server, a device, a component, or other equipment or some combination thereof capable of responding to and executing instructions. These components may receive instructions from, for example, a software application, a program, a piece of code, a device, a computer, a computer system, or a combination thereof, which independently or collectively direct operations, as described herein. The instructions may be embodied permanently or temporarily in any type of machine, component, equipment, storage medium, or propagated signal. Furthermore, when one or more components are used to implement client system 102, content distribution system 104, or advertising system 106, the components may communicate with one another across packet-based or non-packet-based networks to implement the respective functions of client system 102, content distribution system 104, or advertising system 106.

Client systems 102 may execute a hypertext transfer protocol (HTTP) based web browser that presents media pages 102a, such as hypertext markup language (HTML) or other markup language web pages. A media client application 102a-1 may be embedded in a web page 102a presented by the web browser. Media client application 102a-1 presents dynamic content, such as audio content or video content, to a user through, for example, visual, auditory, or tactile presentation devices. Media client application 102a-1 may include a buffer 102a-1a for buffering the dynamic content prior to and during playback of the content. Media client application 102a-1 also may implement a protocol, such as HTTP or the Real Time Streaming Protocol (RTSP), to request the dynamic content.

In addition, the web page may include code 102a-2, such as Javascript code. Code 102a-2 may implement functions for controlling media player 102a-1 (e.g., causing media player 102a-1 to retrieve and/or present content (such as streaming or downloaded dynamic content) pause content, stop playback of content, fast forward content, or rewind content). Code 102a-2 also may implement functions for communicating with other systems, such as to send a request to advertising system 106 for selection of a follow-up ad to be presented by media client application 102a-1 when the presentation of an initial ad is completed. Code 102a-2 may communicate the selection of the follow-up ad to media client application 102a-1 so that media client application 102a-1 can begin buffering the selected follow-up ad from ad server 108 while the initial ad is being presented.

Alternatively, media client application 102a-1 may be a stand-alone application that presents dynamic content such as audio or video content. A stand-alone media client application also may implement HTTP, RTSP, or some other protocol to request the dynamic content, and to communicate with other systems. Examples of a media client application include Windows Media Player from Microsoft Corp. of Redmond, Wash. and RealPlayer from RealNetworks of Seattle, Wash., both of which can be stand-alone or embedded into a web page.

Content distribution system 104 may include a spot replacement system 104a, a master control center 104b, an encoder 104c, and a content server 104d. In general, spot replacement system 104a receives a broadcast feed 112, which includes programming content, from a source 114 and inserts an initial ad into broadcast feed 112 based on control signals 104e received from master control center 104b. The resultant mixed feed 104f (programming content and advertising content) is sent to encoder 104c, along with meta-data 104g associated with the spot break in which the initial ad is inserted.

To that end, spot replacement system 104a includes a spot replacement server 104a-1 and a content switch 104a-2. Spot replacement server 104a-1 sends a request to advertising system 106 for selection of an initial ad, which spot replacement server 104a-1 retrieves from ad server 108. Spot replacement server 104a-1 may use an ad cache which periodically or aperiodically requests selection of an initial ad, retrieves the selected ad, and caches the initial ad so that the initial ad is available when a spot break occurs.

Initially, content switch 104a-2 receives broadcast feed 112 and outputs broadcast feed 112 to encoder 104c on mixed feed 104f. When a spot break occurs, a control signal 104e is sent from master control center 104b to spot replacement server 104a-1. In response to the control signal 104e, spot replacement server 104a-1 sends the initial ad to the content switch 104a-2 on a spot replacement server feed 104a-3, and sends a control signal 104a-4 to content switch 104a-2, which causes content switch 104a-2 to switch from broadcast feed 112 to spot replacement server feed 104a-3. As a result, the initial ad is sent to encoder 104c on mixed feed 104f. In addition, spot replacement server 104a-2 sends meta-data 104g associated with the spot break to encoder 104c.

Encoder 104c encodes mixed feed 104f and the meta-data 104g into a compressed digital stream, and the stream is provided to content server 104d. Content server 104d executes a streaming protocol to respond to a data request from media client application 102a-1 for the live media stream 110. In response to such a data request, content server 104d sends stream 108 (including meta-data) to media client application 102a-1.

Advertising system 106 includes an ad selector module 106a, an ad management campaign database 106b, and an ad management module 106c. As described previously, spot replacement system 104a and code 102a-2 send requests to advertising system 106 for selection of an initial ad (in some implementations, more than one initial ad may be selected and inserted into stream 110) and one or more follow-up ads, respectively. Such requests are received by ad selector module 106a, which selects a particular ad to satisfy the request, and returns an identifier of the ad (for example, a URL) to spot replacement server 104a-1 or code 102a-2. Spot replacement server 104a may use the identifier to retrieve the selected ad from ad server 108 and cache the received ad. Code 102a-2 may use the identifier to instruct media client application 102a-1 to buffer the selected ad from ad server 108.

To select an appropriate ad, ad selector module 106a evaluates business rules regarding various advertising campaigns stored in ad management campaign database 106b to determine a particular ad. The business rules regarding an advertising campaign define the parameters under which an associated ad should be presented, such as the time during which that the ad should be presented (for example, at night or mid-afternoon), the percentage of the population to whom the ad should be presented, the frequency with which the ad should be presented, and/or the geographic location(s) of the users to whom the ad should be presented. Some information useful in selecting an appropriate ad may be transmitted as part of the request for selection of an ad. For example, the type of ad (preview, branding, or advertisement) and the needed duration of the ad may be sent as part of the request. Advertising campaigns and their associated business rules may be entered and/or updated using a campaign manager system 116 (for example, a computer) that communicates with ad management module 106c (for example, a website).

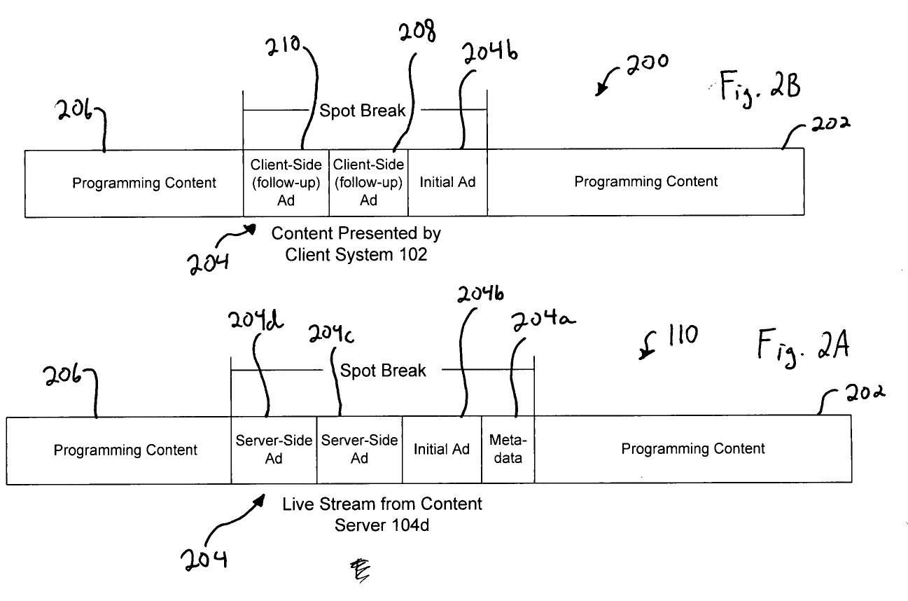

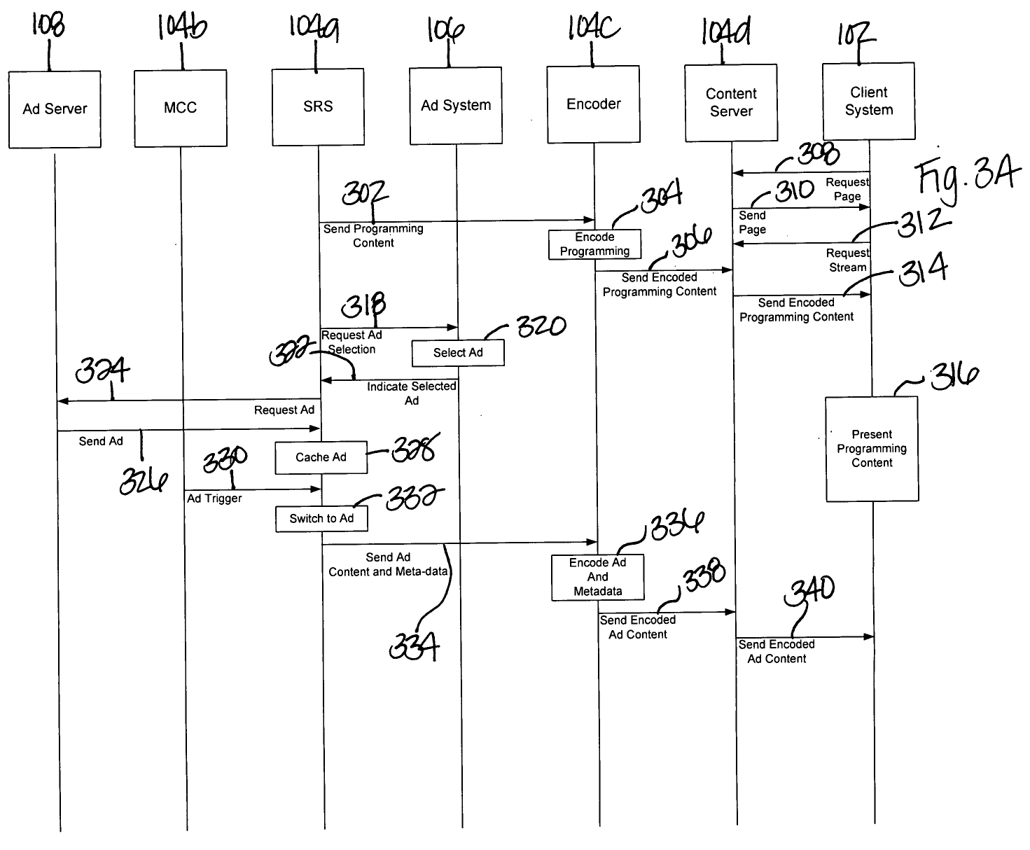

FIGS. 2A and 2B, respectively, show an example of a portion of live media stream 110, and an example of corresponding content 200 presented by media client application 102a-1. As shown in FIG. 2A, live media stream 110 includes a first section of programming content 202, followed by a spot break 204, followed by a second section of programming content 206. At the beginning of spot break 204, live media stream 110 includes meta-data 204a, followed by an initial ad 204b (which is a server-side ad), followed by server-side ads 204c and 204d.

As media client application 102a-1 receives live stream 110, media client application 102a-1 first presents programming content 202. Media client application 102a-1 then detects meta-data 204a at the beginning of spot break 204. Meta-data 204a is not presented by media client application 102a-1, but causes media client application 102a-1 to begin buffering a follow-up ad 208 (a client-side ad). While follow-up ad 208 is being buffered, media client application 102a-1 presents initial ad 204b.

At the end of initial ad 204b, instead of presenting server-side ads 204c and 204d, media client application 102a-1 switches to and presents follow-up ad 208, which was being buffered while initial ad 204b was being presented. Once media client application 102a-1 has presented follow-up ad 208, media client application 102a-1 presents a second follow-up ad 210 (a client-side ad), which may have been buffered while ad 208 was being presented. Finally, once the second follow-up ad 210 has been presented, media client application 102a-1 switches back to live media stream 110 and presents the second section of programming content 206.

Accordingly, instead of presenting server-side ads 204c and 204d, media client application 102a-1 presents client-side ads 208 and 210. Other client systems, however, may choose to present server-side ads 204c and 204d. Furthermore, while broadcast feed 112 is being distributed by content distribution system 104 across, for example, the Internet, broadcast feed 112 also may be distributed by another distribution system across a cable or broadcast television network. In such a case, broadcast feed 112 may include ads inserted during the spot break for distribution on the cable or broadcast television networks (these ads may be referred to as “terrestrial” ads). In some implementations, those same terrestrial ads may be encoded and sent in live stream 110 instead of server-side ads 204a and 204d.

However, there may be reasons to exclude terrestrial ads from live media stream 110. For instance, contractual reasons may prevent the terrestrial ads from being shown on live stream 110. Thus, server-side ads may replace the terrestrial ads to satisfy such obligations. Further, including the server-side ads may be advantageous because they allow ads to be delivered to media client applications that do not perform client-side ad insertion. However, in some implementations, instead of ads being inserted during the spot break, other content or no content may be included in stream 110 during spot break 204.

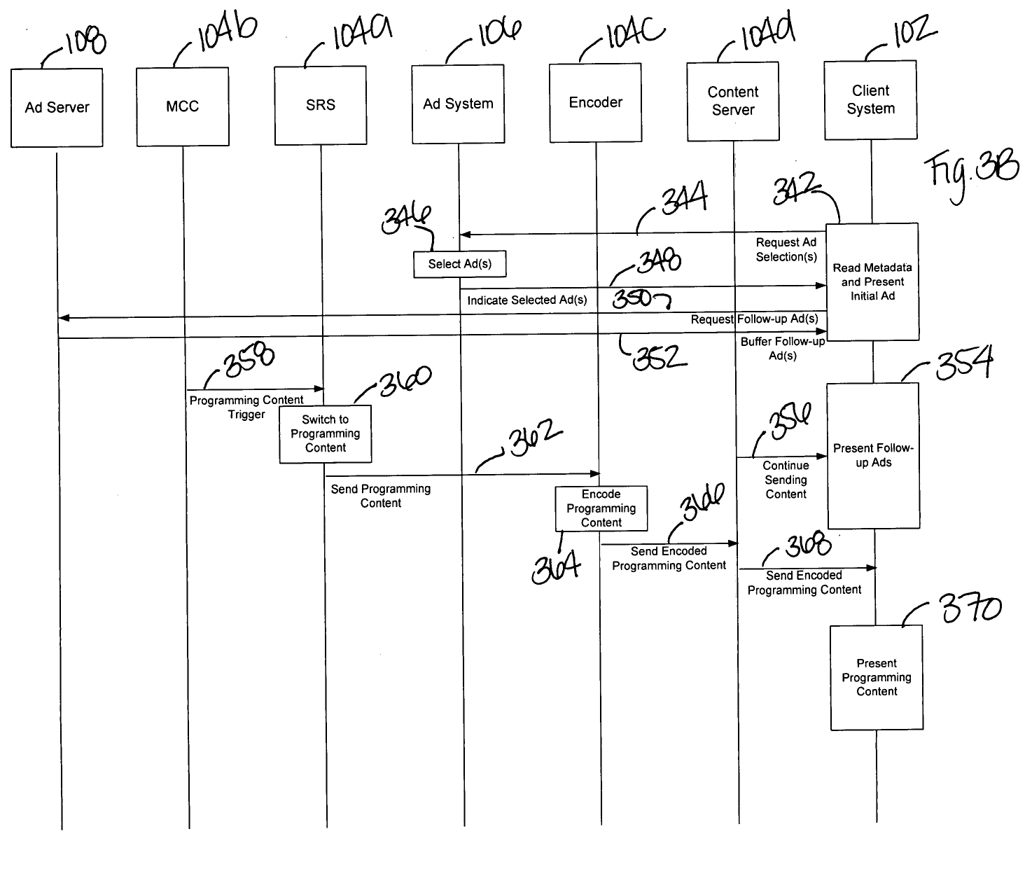

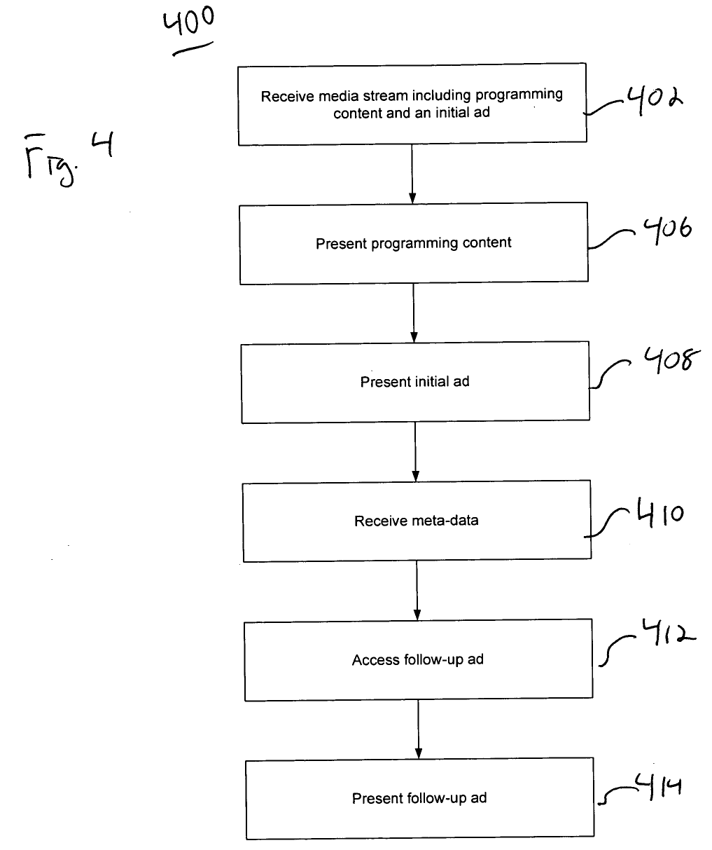

FIGS. 3A and 3B, collectively, illustrate an implementation of the operation of system 100. Referring to FIG. 3A, in general, spot replacement system 104a provides a broadcast feed to encoder 104c. During certain portions of the broadcast feed, spot replacement system 104a provides programming content to encoder 104c (302). Encoder 104c encodes the programming content into an appropriate digital format (304) and makes this stream available to one or more content servers 104d (306). Content servers 104d support multicast capabilities so that the stream may be delivered to multiple client systems, such as client system 102.

Generally, client system 102 communicates with content server 104d to obtain a media page, from which a user can select a live stream, such as the one sent from spot replacement system 104a, for presentation by a client system 102. More specifically, a web browser or media client application executing on a particular client system 102 may request a media page from content server 104d (308). In response to the request, content server 104d provides a media page (310), for example a web page, for presentation by the web browser or media client application.

The web page presents, for a user's selection one or more live streaming selections, including the live stream 110 provided from spot replacement system 104a in operation 302. When a user selects a live stream, the corresponding client system 102 requests the selected live stream (312), which is sent to client system 102 (314) by content server 104d. Client system 102 then begins presenting the live stream, which includes programming content (316).

Before, after, or while client system 102 presents the programming content (316), spot replacement system 104a requests ad selection from ad system 106 (318). The request is received by ad selector module 106a, which selects a particular ad to satisfy the request (320), for example, by evaluating the business rules regarding various advertising campaigns stored in ad management campaign database 106b. Ad system 106 then returns an identifier of the ad (for example, a URL) to the spot replacement system 104a (322). Spot replacement system 104a uses the identifier to request the selected ad from ad server 108 (324), which returns the selected ad (326). Spot replacement system 104a then caches the received ad (328). In other implementations, ad system 106 may directly return the initial ad to the spot replacement system 104a, rather than returning an identifier.

Master control center 104b controls when spot replacement system 104a switches between broadcast feed 112 and spot replacement server feed 104a-3. When a spot break occurs, master control center 104b sends an ad trigger to spot replacement system 104a (330). This trigger may be in the form of, for example, a relay closure, or an extensible mark-up language (XML) feed sent by master control center 104b. In the event the duration of the spot break is to be included in the meta-data, as described below, the ad trigger may include the duration of the spot break, or the spot replacement system 104a may use, for example, a program log to determine the duration of the spot break.

In response to receiving the ad trigger (330), spot replacement system 104a switches to spot replacement server feed 104a-3 (332), which includes the cached ad. Therefore, the cached ad is provided to encoder 104c (334). In addition to the content of the cached ad, spot replacement system 104a provides meta-data associated with the spot break to encoder 104c (334). Encoder 104c encodes the ad content (the initial ad) and meta-data into a digital stream (336) and provides the stream to content server 104d (338), which provides the stream to client system 102 (340). As client system 102 receives the stream (340), client system 102 presents the initial ad (342) included in the stream.

In addition, as client system receives the stream (340), client system detects the meta-data (342). In general, the meta-data cause media client application 102a-1 on client system 102 to begin buffering one or more follow-up ads while the initial ad is presented (342), as described above and further below. The meta-data can be encoded at the beginning of the spot break as shown in FIG. 2A, or a short period after the beginning of the spot break (e.g., part way into the initial ad). Preferably, however, the meta-data is encoded at a point that allows media client application 102a-1 to buffer a follow-up ad such that media client application 102a-1 can switch immediately to the follow-up ad when the initial ad is finished.

The form and content of the meta-data may depend on the technology used to generate live stream 110, and the parameters needed to properly select the follow-up ads. For example, one technology for encoding live streams is known as Windows Media®. Products for encoding video and audio sources into Windows Media® streams are available from Microsoft Corp. of Redmond, Wash. under the names Windows Media Encoder and Windows Media Services. In addition, as described above, a media client application for presenting Windows Media® streams is Windows Media Player®, also available from Microsoft Corp.

In the Windows Media® format, meta-data such as events can be inserted inside the media stream. These events are not visible or audible but instead serve as markers in the stream that can be detected and acted upon by the media client application 102a-1. One form of event that can be embedded in a live stream is known as a custom event. When a custom event is detected by the media client application, the media client application causes custom code to be executed. The custom event may include parameters that are passed to the code.

Accordingly, in an implementation employing Windows Media® streams, the meta-data associated with a spot break in live stream 110 may be a custom event that causes media client application 102a-1 to execute a portion of code 102a-2. The executed portion of code 102a-2 on client system 102 selects one or more follow-up ads by sending a request for ad selection (344) to ad system 106. The request may include, for example, the length of the spot break, minus the length of the initial ad so that an appropriate number and length of follow-up ads can be selected to fill the time remaining in the spot break after the initial ad. For example, if the spot break is one-minute long and the initial ad is 15 seconds long, then ad system 106 may select a 30 second ad and a 15 second ad, may select three 15 second ads, or may select some other combination of number and length of ads.

In the event that the spot break and initial ad is of a known, fixed length, then this information may be included in code 102a-2, which then includes the information in the request for ad selection (344). In the event that the length of the spot break and/or the length of the initial ad are not of a known fixed length, then the values of one or both of these lengths may be included as a parameter in the custom event, and passed to code 102a-2 so that code 102a-2 can include the information in the request for ad selection (344).

The request for ad selection (344) may include other parameters, such as an identifier (for example, a globally unique identifier (GUID)) associated with client system 102, or a user of client system 102. This may allow ad system 106 to select follow-up ads targeted to the user of client system 102.

In response to the request for ad selection (344), ad system 106 selects one or more follow-up ads (346). Ad system 106 then returns an identifier for each selected follow-up ad to code 102a-2 on client system 102 (348). In an alternate implementation, code 102a-2 includes logic that selects the one or more follow-up ads, rather than requesting selection from ad system 106. In addition, in other implementations, ad system 106 may return the selected follow-up ads, rather than an identifier.

Once code 102a-2 selects the one or more follow-up ads (for example, with internal logic or by requesting selection from ad system 106), code 102a-2 passes the identifiers of the follow-up ads to media client application 102a-1 and instructs media client application 102a-1 to begin buffering the one or more follow-up ads. To do so, media client application 102a-1 on client system 102 requests the one or more follow-up ads (350) from ad server 108, which begins streaming the one or more follow-up ads to media client application 102a-1 on client system 102 (352). Media client application 102a-1 receives the ad stream containing the follow-up ads from ad server 108 and begins buffering the stream (and, hence, the one or more follow-up ads) (352).

When media client application 102a-1 finishes presenting the initial ad (342), media client application 102a-1 switches to the ad stream to present the one or more follow-up ads (354). For example, the duration of the initial ad may be included in the meta-data, or may be a known, fixed length. Based on this information, media client application 102a-1 may determine when the initial ad is finished being presented and switch to the ad stream at that point. As another alternative, another piece of meta-data may be encoded in the live stream to indicate the end of the initial ad and, upon detecting this piece of meta-data, media client application 102a-1 may switch to the ad stream.

While presenting the ad stream containing the one or more follow-up ads (354), media client application 102a-1 may continue to receive and buffer live media stream 110 from content server 104d (which, at this point, may include other server-side ads, or other content, as described above) (356). As described below, this may allow for a smooth transition back to live media stream 110. This also may allow additional meta-data, encoded in live media stream 110, to cause media client application 102a-1 to switch back to the live media stream in the event that the duration of the spot break is cut short.

At the end of the spot break, a programming content trigger is sent from master control center 104b to spot replacement system 104a (358). In response, spot replacement system 104a switches back to broadcast feed 112, which includes the programming content (360). Alternatively, spot replacement system 104a may determine the end of the spot break based on the spot break duration, and switch back to broadcast feed 112 without a programming content trigger 360.

Switching to broadcast feed 112 results in programming content being sent to encoder 104c (362), which encodes the programming content (364). Encoder 104c provides the encoded programming content to content server 104d (366), which provides the encoded content to media client application 102a-1 of client system 102 (368).

When the encoded programming content is sent to client system 102, media client application 102a-1 switches back to the live media stream to present the programming content (370). As described above, media client application 102a-1 may continue to receive and buffer live media stream 110 from content server 104d while presenting the ad stream so that the switch back to the live media stream may occur without a buffering delay.

If the duration of the spot break is equal to the expected length of the spot break (for example, either the known, fixed length or the length sent to client system 102 by spot replacement system 104a), then the beginning of the programming content and the end of the follow-up ads will coincide. In this case, media client application 102a-1 may simply be instructed by code 102a-2 to switch to live media stream 110 after presenting the ad stream. For example, code 102a-2 may determine the end of the follow-up ads, for instance, by determining the end of the follow-up ads based on the duration of the spot break, or based on an event passed from media client application 102a-1 to code 102a-2 that indicates that media client application 102a-1 has finished presenting the follow-up ads. Code 102a-2 then may instruct the media client application 102a-1 to switch back to the live media stream.

In some situations, however, the duration of the spot break may be shorter than expected. For example, there may be a decision during the spot break to return to the programming content before the expected end of the spot break (generally referred to as a “cut back”). When a cut back occurs, a piece of meta-data may be encoded in live media stream 110 at the time of the cut back. When media client application 102a-1 continues to receive live media stream 110 (356) while presenting the follow-up ads (354), media client application 102a-1 detects this piece of meta-data, which causes media client application 102a-1 to switch back to live stream 110 at the point when the meta-data is detected. For example, in a Windows Media® implementation, this meta-data may be another custom event that causes the media client application 102a-1 to execute code in 102a-2 that causes media client application 102a-1 to stop presenting the follow-up ads and switch back to live media stream 110.

In some implementations, such meta-data may be included at the end of the spot break regardless of whether the spot break lasts for the expected duration or is finished earlier. Doing so may insure that media client application 102a-1 switches back to the live media stream at the beginning of the programming content.

The techniques used to switch between presenting live media stream 110 and an ad stream containing one or more follow-up ads, while buffering each prior to presentation, may depend on the technology used to implement media client application 102a-1. For example, if media client application 102a-1 only handles a single stream, then two instances of media client application 102a-1 may be used to implement switching between streams. In this case, one instance of media client application 102a-1 is used for live media stream 110, while the second instance of media client 102a-1 is used for the ad stream. The first instance (live media stream) is shown while live media stream 110 is being presented, while the second instance (ad stream) is hidden. When the switch from live media stream 110 to the ad stream is to occur, the first instance (live media stream) is hidden, and the second instance (ad stream) is shown in its place. Conversely, in an implementation in which live media stream 110 is buffered while the follow-up ads are presented (356), the second instance (ad stream) is hidden and the first instance (live media stream) is shown in its place when the switch from the ad stream to the live media stream is to occur.

More generally, referring to FIG. 4, a process 400 may be performed, for example, by client system 102. Client system 102 may receive a media stream (for example, a live media stream) that includes programming content and an initial ad after the programming content (402). The client system may present the programming content segment (404). Client system 102 may present the initial ad after the programming content (406). Prior to an end of the presentation of the initial ad, client system 102 may receive meta-data (408). In response to receiving the meta-data, client system 102 accesses a follow-up ad to be presented after the initial ad (410). Client system 102 then presents the follow-up ad after presenting the initial ad (412).

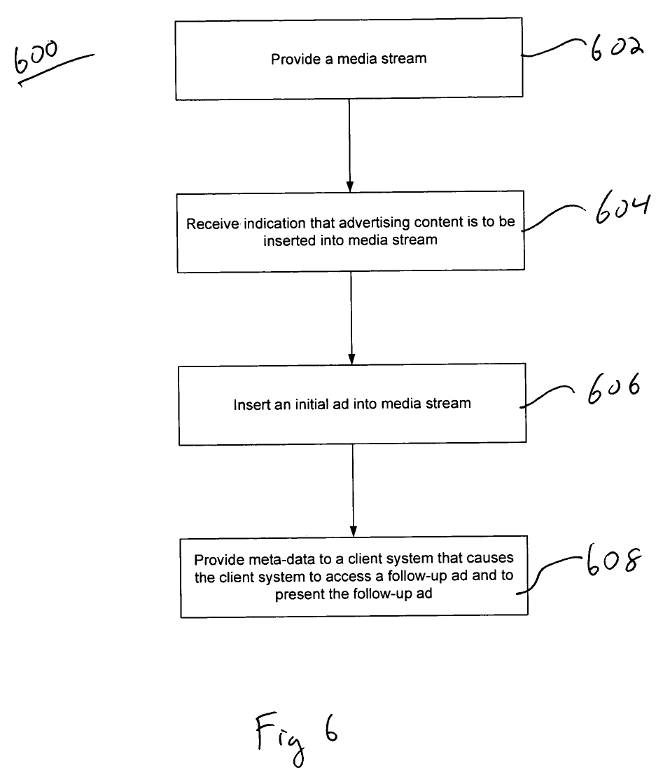

Referring to FIG. 5, a process 500 may generally be performed, for example, by ad system 106. Ad system 106 receives a request for selection of an initial ad for insertion into a media stream being sent to a client system (502). Ad system 106 selects the initial ad such that the initial ad has a length that allows the client system to access a follow-up ad while presenting the initial ad (504). Ad system 106 provides an indication of the selected initial ad for insertion into the media stream being sent to the client system (506). Ad system 106 receives, from the client system, a request for selection of the follow-up ad (508) and selects the follow-up ad (510). Ad system 106 provides an indication of the selected follow-up ad to the client system to allow the client system to access the selected follow-up ad while the client system is presenting the initial ad (512).

Referring to FIG. 6, a process 600 may generally be performed, for example, by content distribution system 104. Content distribution system 104 provides a media stream for transmission to a client system (602). The media stream includes programming content. Content distribution system 104 receives an indication that advertising content is to be inserted into the media stream (604) and inserts an initial ad into the media stream (606). The initial ad has a length that allows the client system to access a follow-up ad while presenting the initial ad. Content distribution system 104 provides an indication, for example, in the media stream, that the client system is to access the follow-up ad while presenting the initial ad and to present the follow-up ad after presenting the initial ad (608).

The techniques described above are not limited to any particular hardware or software configuration. Rather, they may be implemented using hardware, software, firmware or a combination of them. The methods and processes described may be implemented as computer programs that are executed on programmable computers comprising, for example, at least one processor and at least one data storage system. The programs may be implemented in a high-level programming language and may also be implemented in assembly or other lower level languages, if desired.

Any such program will typically be stored on a computer-usable storage medium or device (for example, CD-Rom, RAM, or magnetic disk). When read into the processor of the computer and executed, the instructions of the program cause the programmable computer to carry out the various operations described above.

A number of implementations have been described. Nevertheless, it will be understood that various modifications may be made. For example, while the techniques are described above as applied to streaming ads, they may be applied to downloaded ads. Also, while meta-data is described as included in a stream, the meta-data may be sent on a channel separate from the stream. However, including the meta-data in the stream may help to insure proper synchronization of the events associated with the meta-data. Accordingly, other implementations are within the scope of the following claims.

What is claimed is:

1. A method comprising:
receiving a media stream, the media stream including programming content and an initial ad after the programming content;
presenting the programming content;
presenting the initial ad after the programming content;
receiving, prior to an end of the presentation of the initial ad, meta-data;
in response to receiving the meta-data, accessing a follow-up ad to be presented after the initial ad; and
presenting the follow-up ad after presenting the initial ad.

2. The method of claim wherein receiving meta-data comprises receiving meta-data encoded in the media stream.

3. The method of claim 2 wherein the meta-data is encoded at a point in the media stream prior to the end of the initial ad that allows the follow-up ad to be accessed and at least a portion of the follow-up ad to be buffered prior to the end of the presentation of the initial ad.

4. The method of claim 1 wherein accessing the follow-up ad comprises accessing the follow-up ad while presenting the initial ad.

5. The method of claim 4 wherein accessing the follow-up ad while presenting the initial ad comprises buffering at least a portion of the follow-up ad while presenting the initial ad.

6. The method of claim 1 wherein accessing the follow-up ad comprises accessing the follow-up ad from a source other than a source from which the media stream is received.

7. The method of claim 1 wherein receiving the media stream comprises receiving a live media stream.

8. A method comprising:
receiving a request for selection of an initial ad for insertion into a media stream being sent to a client system;
selecting the initial ad such that the initial ad has a length that allows the client system to access a follow-up ad while presenting the initial ad;
providing an indication of the selected initial ad;
receiving, from the client system, a request for selection of the follow-up ad;
selecting the follow-up ad; and
providing an indication of the selected follow-up ad to the client system allow the client system to access the selected follow-up ad while the client system is presenting the initial ad.

9. The method of claim 8 wherein providing an indication of the selected initial ad comprises providing an identifier of the selected initial ad.

10. The method of claim 9 wherein the identifier of the initial ad comprises a URL.

11. The method of claim 8 wherein providing an indication of the selected follow-up ad comprises providing an identifier of the selected follow-up ad.

12. The method of claim 8 wherein providing an indication of the selected follow-up ad comprises providing the selected follow-up ad.

13. The method of claim 8 wherein receiving, from the client system, a request for selection of the follow-up ad comprises receiving, from the client system, a request for selection of a follow-up ad while the client system is presenting the initial ad.

14. The method of claim 8 wherein selecting the follow-up ad comprises selecting a follow-up ad while the client system is presenting the initial ad.

15. The method of claim 8 wherein the follow-up ad comprises one or more of: an advertisement, a preview, and a branding segment.

16. The method of claim 8 wherein selecting the initial ad such that the initial ad has a length that allows the client system to access a follow-up ad while presenting the initial ad comprises selecting the initial ad such that the initial ad has a length that allows the client system to access and buffer at least a portion of the selected follow-up ad while presenting the initial ad.

17. A method comprising:
providing a media stream for transmission to a client system, the media stream including programming content;
receiving an indication that advertising content is to be inserted into the media stream;
inserting an initial ad into the media stream, the initial ad having a length that allows the client system to access a follow-up ad while presenting the initial ad; and
providing meta-data to the client system, the meta-data causing the client system to access the follow-up ad while presenting the initial ad and to present the follow-up ad after presenting the initial ad.

18. The method of claim 17 wherein providing the meta-data comprises providing the meta-data in the media stream before the initial ad.

19. The method of claim 17 wherein the meta-data includes an indication of a length of time during which the follow-up ad may be presented.

20. A computer-usable medium having a computer program embodied thereon, the computer program comprising instructions for causing a computer to perform the following operations:
receive a media stream, the media stream including programming content and an initial ad after the programming content;
present the programming content;
present the initial ad after the programming content;
receive, prior to an end of the presentation of the initial ad, meta-data;
in response to receiving the meta-data, access a follow-up ad to be presented after the initial ad; and
present the follow-up ad after presenting the initial ad.
